(19) United States
(12) Patent Application Publication
(10) Pub. No.: US 2021/0143429 A1
(43) Pub. Date: May 13, 2021

(54) METHOD AND SYSTEM FOR TAPE CASTING ELECTRODE ACTIVE MATERIAL

(71) Applicant: Enevate Corporation, Irvine, CA (US)

(72) Inventor: BENJAMIN PARK, Mission Viejo, CA (US)

(21) Appl. No.: 16/677,118

(22) Filed: Nov. 7, 2019

(51) Int. Cl. H01M 4/66; H01M 10/0525; H01M 4/36

(52) U.S. Cl. CPC H01M 4/66; H01M 4/366; H01M 10/0525

(57) ABSTRACT

Systems and methods are provided for producing an electrode comprising a current collector and an active material. The active material is tape cast and laminated to the current collector. This electrode may be used as the anode and/or cathode of a lithium-ion battery. The tape casting may be performed by coating a device with a slurry and allowing the slurry to dry. The device may be, for example, a stainless steel drum or a belt having a low adhesion. The slurry may be pealed from the device as a laminate layer. One or more laminate layers may be adhered to the current collector that is subsequently pyrolyzed.

### FIELD

Aspects of the present disclosure relate to energy generation and storage. More specifically, certain embodiments of the disclosure relate to a method and system for tape casting electrode active material.

### BACKGROUND

Conventional approaches for battery anodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method are provided for tape casting electrode material, where such an electrode is used in a battery with a silicon-dominant anode, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery with anode expansion configured via silicon particle size, in accordance with an example embodiment of the disclosure.

FIG. 2 illustrates anode expansion during lithiation, in accordance with an example embodiment of the disclosure.

FIG. 3 illustrates a system for tape casting electrode active material, in accordance with an example embodiment of the disclosure.

FIG. 4 is a flow diagram of a process for tape casting of electrodes, in accordance with an example embodiment of the disclosure.

### DETAILED DESCRIPTION

FIG. 1 is a diagram of a battery with a silicon-dominant anode that experiences anode expansion, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 107B. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a lithiation/delithiation voltage plateau at about 0.3-0.4V vs. Li/Li₊, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

FIG. 2 illustrates anode expansion during lithiation, in accordance with an example embodiment of the disclosure. Referring to FIG. 2, there are shown a current collector 201, an optional adhesive 203, and an active material 205. It should be noted that the adhesive 203 may or may not be present depending on the type of anode fabrication process utilized, as the adhesive is not necessarily there in a direct coating process where the active material is formed directly on the current collector and may not be needed in a tape casting process. In an example scenario, the active material 205 comprises silicon particles in a binder material and a solvent, the active material 205 being pyrolyzed to turn the binder into a pyrolyzed carbon that provides a structural framework around the silicon particles and also provides electrical conductivity. The active material may be coupled to the current collector 201 using the optional adhesive 203. The current collector 201 may comprise a metal film, such as copper, nickel, or titanium, for example, although other conductive foils may be utilized depending on desired tensile strength.

FIG. 2 also illustrates lithium ions impinging upon and lithiating the active material 205. The lithiation of silicon-dominant anodes causes expansion of the material, where horizontal expansion is represented by the x and y axes, and thickness expansion is represented by the z-axis, as shown. The current collector 201 has a thickness t, where a thicker foil provides greater strength and providing the adhesive 203 is strong enough, restricts expansion in the x- and y-directions, resulting in greater z-direction expansion, thus anisotropic expansion. Example thicker foils may be greater than 6 μm, such as 10 μm or 20 μm for copper, for example, while thinner foils may be less than 6 μm thick in copper.

In another example scenario, when the current collector 201 is thinner, on the order of 5-6 μm for a copper foil, for example, the active material 205 may expand more easily in the x- and y-directions, although still even more easily in the z-direction without other restrictions in that direction. In this case, the expansion is anisotropic, but not as much as compared to the case of higher x-y confinement.

In addition, different materials with different tensile strength may be utilized to configure the amount of expansion allowed in the x- and y-directions. For example, nickel is a more rigid, mechanically strong metal for the current collector 201, and as a result, nickel current collectors confine x-y expansion when a strong enough adhesive is used. In this case, the expansion in the x- and y-directions may be more limited, even when compared to a thicker copper foil, and result in more z-direction expansion, i.e., more anisotropic. In anodes formed with 5 μm nickel foil current collectors, very low expansion and no cracking results. Furthermore, different alloys of metals may be utilized to obtain desired thermal conductivity, electrical conductivity, and tensile strength, for example.

In an example scenario, when an adhesive is used, the adhesive 203 comprises a polymer such as polyimide (PI) or polyamide-imide (PAI) that provides adhesive strength of the active material film 205 to the current collector 201 while still providing electrical contact to the current collector 201. Other adhesives may be utilized depending on the desired strength, as long as they can provide adhesive strength with sufficient conductivity following processing. If the adhesive 203 provides a stronger, more rigid bond, the expansion in the x- and y-directions may be more restricted, assuming the current collector is also strong. Conversely, a more flexible and/or thicker adhesive may allow more x-y expansion, reducing the anisotropic nature of the anode expansion.

FIG. 3 illustrates a system for tape casting electrode active material, in accordance with an example embodiment of the disclosure. FIG. 3 illustrates a parallel system in which slurry 301, belt 303, dryer 305 and peeler 307 are duplicated to enable lamination on both sides of a current collector. This disclosure also encompasses an embodiment that uses only a single stage of slurry 301, belt 303, dryer 305 and peeler 307 as well as an embodiment that uses more than two stages.

An active material is added to slurry 301. This active material slurry 301 is applied as if painted to belt device 303. The active material slurry 301 is dried by dryer 305 and then peeled from the belt device 303 by peeler 307. The peeled layers 309 and 311 of dried active material slurry are adhered to the current collector that may be in a metal foil roll 315. Typically the metal foil roll 315 comprises copper for anodes and nickel for cathodes.

After being laminated, pyrolysis 317 may be performed on the laminated current collector. Following pyrolysis 317, the pyrolyzed, laminated current collector may be cut and/or separated into pieces to form an electrode 319. Accordingly, the tape casting of active material and lamination of the current collector may be a continuous process. This disclosure also encompasses an embodiment that produces each electrode one-at-a-time.

After heat treatment (i.e., pyrolysis), the layers 309 and 311 of dried active material slurry are brittle. Tape casting the electrode in its preheat-treated form allows the layers' plasticity and flexibility to aid lamination straight on the current collector (e.g., copper or nickel). Tape casting does not require coating on a film. Rather, tape casting uses a drum or belt and the cast layer is peeled from the drum or belt. This process of coating, drying and peeling may be performed as a continuous fast process. The pyrolysis temperature is limited to being lower than a silicon reaction temperature (e.g., less than 800° C.) if the silicon is touching the current collector. If the adhesive layer allows for a separation between the silicon and the current collector metal, the pyrolysis can go higher to around 900-1300° C.—ideally around 900-1200° C.

An example tape cast electrode, in accordance with the present disclosure, comprises an active material (layer 1 and/or layer 2) that is tape cast and laminated to metal foil 315.

An example method of producing an electrode, in accordance with the present disclosure, comprises tape casting an active material layer, laminating the active material layer to a current collector, and pyrolyzing the laminated current collector.

The tape cast electrode may be used in a battery as the anode and/or the cathode. As an anode the tape cast electrode may comprise a copper current collector. As a cathode the tape cast electrode may comprise a nickel current collector. The battery may be a lithium-ion battery.

The tape casting comprises coating a device with a slurry of active material, and upon drying, the slurry is pealed from the device as a layer. The coated device may be a stainless steel drum or a belt having a low adhesion. The layer of dried active material slurry may be laminated to the current collector. This lamination may comprise a plurality of layers, wherein at least one layer of the plurality of laminated layers comprises active material. The laminated active material is pyrolyzed after being attached to the electrode.

FIG. 4 is a flow diagram of a process for tape casting of electrodes, in accordance with an example embodiment of the disclosure.

This process is shown in the flow diagram of FIG. 4, starting with step 401 where the active material may be mixed with a binder/resin such as polyimide (PI) or polyamide-imide (PAI), solvent, the silosilazane additive, and optionally a conductive carbon. Graphene/VGCF (1:1 by weight) may be dispersed in NMP under sonication for, e.g., 45-75 minutes followed by the addition of Super P (1:1:1 with VGCF and graphene) and additional sonication for, e.g., 1 hour. Silicon powder with a desired particle size, may then be dispersed in polyamic acid resin (10-20% solids in N-Methyl pyrrolidone (NMP)) at, e.g., 800-1200 rpm in a ball miller for a designated time, and then the conjugated carbon/NMP slurry may be added and dispersed at, e.g., 1800-2200 rpm for, e.g., another predefined time to achieve a slurry viscosity within 2000-4000 cP and a total solid content of about 20-40%. The particle size and mixing times may be varied to configure the active material density and/or roughness.

In step 403, the slurry may be coated on a drum or belt as in FIG. 3. For example, the belt may comprise a polymer substrate with low adhesion, such as polyethylene terephthalate (PET), polypropylene (PP), or Mylar, or may comprise a stainless steel drum. The slurry may be coated at a loading of 3-4 mg/cm² (with 15% solvent content), and then dried to remove a portion of the solvent in step 405. An optional calendering process may be utilized where a series of hard pressure rollers may be used to finish the film/substrate into a smoothed and denser sheet of material.

In step 407, the green film may then be removed, where the active material may be peeled off the drum or belt

In step 409, the peeled layer may be flat press or roll press laminated on the current collector, where a metal foil may optionally be coated with polyamide-imide with a nominal loading of 0.35-0.75 mg/cm² (applied as a 5-7 wt % varnish in NMP, dried 10-20 hour at 100-140° C. under vacuum). In flat press lamination, the peeled layer may be laminated to the coated metal foal using a heated hydraulic press (30-70 seconds, 250-350° C., and 3000-5000 psi), thereby forming a laminated foil. In another embodiment, the peeled layer may be roll-press laminated to the current collector.

The lamination may be followed by a cure and pyrolysis step 411, and vacuum dried using a two-stage process (100-140° C. for 15 h, 200-240° C. for 5 h). The laminated foil may be thermally treated at 1000-1300° C. to convert the polymer matrix into carbon. The pyrolysis step may result in an electrode active material having silicon content greater than or equal to 50% by weight, where the electrode has been subjected to heating at or above 400° C.

In step 413, the pyrolyzed, laminated substrate may be cut to form an individual electrode. The electrode may be configured as the anode or the cathode of a lithium-ion battery. An anode, a separator and a cathode may be sandwiched with an electrolyte to form a battery cell. The cell may be subjected to a formation process, comprising initial charge and discharge steps to lithiate the anode, with some residual lithium remaining. The expansion of the anode may be measured to confirm reduced expansion and anisotropic nature of the expansion. The larger silicon particle size results in a rougher surface, higher porosity and less dense material, which reduces the expansion of the active material during lithiation.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. An electrode assembly system, the electrode assembly system comprising:
a belt having a low adhesion, wherein the belt is operable to receive an active material;
a dryer operable to dry the active material to produce a tape cast layer comprising the active material, wherein the active material is configured to produce a pyrolyzed material; and
a peeler operable to remove the tape cast layer, wherein the tape cast layer is configured for adhesion to a current collector.

2. The electrode assembly system according to claim 1, wherein a battery comprises the tape cast layer in an anode.

3. The electrode assembly system according to claim 1, wherein a battery comprises the tape cast layer in a cathode.

4. The electrode assembly system according to claim 1, wherein a lithium-ion battery comprises the tape cast layer.

5. The electrode assembly system according to claim 1, wherein the tape cast layer is laminated to the current collector.

6. The electrode assembly system according to claim 1, wherein an electrode comprises a plurality of laminated layers, and wherein at least one laminated layer of the plurality of laminated layers comprises the active material.

7. The electrode assembly system according to claim 1, wherein the active material is configured to be pyrolyzed after being laminated to the current collector.

8. The electrode assembly system according to claim 1, wherein the tape cast layer comprises a dried slurry, and wherein the dried slurry is peeled from the belt in a layer.

9. (canceled)

10. (canceled)

11. A method for producing an electrode, the method comprising:
tape casting an active material;
laminating the tape cast active material to a current collector; and
pyrolyzing the laminated current collector to produce the electrode.

12. The method according to claim 11, wherein the method comprises producing a battery using the electrode as an anode.

13. The method according to claim 11, wherein the method comprises producing a battery using the electrode as a cathode.

14. The method according to claim 11, wherein the method comprises laminating the active layer to the current collector by utilizing a polymer adhesive layer for the adhesion.

15. The method according to claim 11, wherein the method comprises producing a lithium-ion battery with the electrode.

16. The method according to claim 11, wherein the method comprises laminating a plurality of layers to the current collector, and wherein at least one layer of the plurality of layers comprises the active material.

17. The method according to claim 11, wherein the active material is pyrolyzed after being attached to the current collector.

18. The method according to claim 11, wherein the tape casting comprises coating a device with a slurry, and wherein upon drying, the slurry is pealed from the device as a layer.

19. The method according to claim 18, wherein the device is a stainless steel drum.

20. The method according to claim 18, wherein the device is a belt having a low adhesion.

21. An electrode assembly system, the electrode assembly system comprising:
a first belt operable to receive a first active material;
a second belt operable to receive a second active material;
a dryer operable to dry the first active material and the second active material to produce a first tape cast layer and a second tape cast layer; and
a peeler operable to remove the first tape cast layer and the second tape cast layer, wherein:
the first tape cast layer and the second tape cast layer are configured for adhesion to a current collector comprising a first side and a second side,
the first tape cast layer is on the first side of the current collector,
the first tape cast layer comprises an active material configured to produce a pyrolyzed material, and
the second tape cast layer is on the second side of the current collector.

22. The electrode assembly system according to claim 21, wherein a battery comprises the first tape cast layer and second tape cast layer in an anode.

23. The electrode assembly system according to claim 21, wherein a battery comprises the first tape cast layer and second tape cast layer in a cathode.

24. The electrode assembly system according to claim 21, wherein a lithium-ion battery comprises the first tape cast layer and second tape cast layer.

25. The electrode assembly system according to claim 21, wherein the first tape cast layer and the second tape cast layer are laminated to the current collector.

26. The electrode assembly system according to claim 21, wherein the second tape cast layer is configured to produce a pyrolyzed material.

27. The electrode assembly system according to claim 21, wherein the first active material is configured to be pyrolyzed after being laminated to the current collector.

28. The electrode assembly system according to claim 21, wherein the first tape cast layer is peeled from a first device and the second tape cast layer is peeled from a second device.

29. (canceled)

30. The electrode assembly system according to claim 21, wherein the first belt and the second belt each comprise a low adhesion.
